(19) United States
(12) Patent Application Publication
(10) Pub. No.: US 2026/0338319 A1
(43) Pub. Date: Oct. 29, 2026

(54) EXTENDABLE LEG

(71) Applicant: Huizhou Flex Smart Furniture Co., Ltd., Huizhou (CN)

(72) Inventor: Guohong Zeng, Huizhou (CN)

(21) Appl. No.: 19/702,178

(22) Filed: Jun. 9, 2026

(30) Foreign Application Priority Data
Nov. 11, 2025 (CN) 202522393830.1

(51) Int. Cl. F16M 11/26

(52) U.S. Cl. CPC F16M 11/26

(57) ABSTRACT

The present disclosure belongs to the technical field of furniture accessories and provides an extendable leg, to solve problems of a limited support range, poor stability, a non-adjustable length, and susceptibility to wear and floor scratching in conventional bed frame support legs. The extendable leg includes a support leg mounted at a bottom of a bed frame through an extendable member, where the extendable member is a foldable structure or a telescopic structure. The foldable extendable member is connected by multiple connecting square rods through hinges. This extendable leg can expand a support range, adjust a length of the support leg, improve the stability of the bed frame, adapt to different heights and floor flatness, and also extend service life, reduce noise, and prevent floor scratching.

### FIELD OF TECHNOLOGY

The present disclosure relates to the technical field of furniture accessories, and in particular to an extendable leg.

### BACKGROUND

Support legs of conventional bed frames are typically fixed to inner sides of bottoms of bed frames, resulting in a limited support range. When the bed frames are large or placed on an uneven surface, insufficient support easily causes shaking, thereby affecting stability during use. Some support legs of the bed frames have fixed lengths, which cannot be adapted to varying floor levels or bed frame height requirements. Additionally, because the support legs are in direct contact with the floor, friction may cause wear to the legs, scratching of the floor, and generation of noise. To resolve the above problems, the extendable leg of the present disclosure expands the support range through a foldable or telescopic extendable member, and, in combination with an adjustable-length support leg and protective structure, problems of insufficient support stability, poor adaptability, easy wear found in the conventional support legs, and the like are resolved.

### SUMMARY

The present disclosure provides an extendable leg, to address the problems raised in the background.

Specific technical solutions are as follows:
an extendable leg, including a support leg mounted at a bottom of a bed frame through a first extendable member or a second extendable member, where
the first extendable member is a foldable structure; and the second extendable member is a telescopic structure.

In a preferred solution of the present disclosure, the first extendable member includes at least two connecting square rods, adjacent connecting square rods are connected by a hinge, a bottom of an outermost connecting square rod is connected to an upper end of the support leg, and an innermost connecting square rod is fixedly mounted at the bottom of the bed frame.

In a preferred solution of the present disclosure, adjacent connecting square rods are connected by two symmetrically arranged hinges, and after a hinge on one side is removed, the adjacent connecting square rods can be folded.

In a preferred solution of the present disclosure, the second extendable member includes a straight rod fixedly mounted to the bottom of the bed frame, a slide rail fixedly mounted on both sides of the straight rod, a U-shaped connecting base slidably mounted on an outer side of the slide rail through a slider, and a connecting plate integrally formed at an outer end of the U-shaped connecting base, where a bottom of one end of the connecting plate away from the U-shaped connecting base is connected to an upper end of the support leg.

In a preferred solution of the present disclosure, at least four sliders are provided, the sliders are slidably engaged with the slide rail, and the sliders are fixedly connected to the U-shaped connecting base.

In a preferred solution of the present disclosure, the support leg includes two support cylinders, a first connecting piece is fixedly mounted inside a lower support cylinder, a second connecting piece is fixedly mounted inside an upper support cylinder, a connecting base is fixedly mounted at an upper end of the upper support cylinder, the second connecting piece is connected to the first connecting piece by a first screw, and the connecting base is connected to a bottom of the outermost connecting square rod or a bottom of the connecting plate by a second screw.

In a preferred solution of the present disclosure, after the first screw is tightened, a bottom end of the upper support cylinder abuts against an upper end of the lower support cylinder; and after the second screw is tightened, the connecting base abuts against a bottom of the connecting square rod or a bottom of the connecting plate.

In a preferred solution of the present disclosure, a protective cover is sleeved on a bottom end of the lower support cylinder.

The present disclosure has the following beneficial effects.
1. The support leg can extend outward from the bed frame through folding of the first extendable member or telescoping of the second extendable member, thereby expanding a support range of the bed frame and significantly enhancing the overall support stability.
2. The support leg has a structure in which the two support cylinders are connected by the first connecting piece, the second connecting piece, and the first screw, allowing flexible adjustment of a length of the support leg, to meet different bed frame height or floor level requirements.
3. Fastening design of the first screw and the second screw eliminates gaps between the support cylinders and between the support leg and the extendable member, preventing shaking during use and further enhancing support reliability.
4. The protective cover at the bottom end of the lower support cylinder reduces wear on the support cylinder, extends service life, and lowers noise generated from contact with the floor, preventing floor scratches.
5. The hinge of the first extendable member and the cooperation between the slide rail and the slider of the second extendable member balance structural strength and ease of adjustment, ensuring that the support leg is extended stably and smoothly.

### BRIEF DESCRIPTION OF THE DRAWINGS

FIG. 1 is a first schematic structural diagram of an extendable leg according to an embodiment of the present disclosure;

FIG. 2 is a second schematic structural diagram of the extendable leg according to an embodiment of the present disclosure;

FIG. 3 is a partial sectional schematic structural diagram of the extendable leg according to an embodiment of the present disclosure;

FIG. 4 is an enlarged schematic structural diagram of part A in FIG. 3;

FIG. 5 is a third schematic structural diagram of the extendable leg according to an embodiment of the present disclosure; and

FIG. 6 is an exploded schematic structural diagram of FIG. 5.

In the drawings:
1, first extendable member; 101, connecting square rod; 102, hinge;
2, second extendable member; 201, straight rod; 202, slide rail; 203, slider; 204, connecting plate; 205, U-shaped connecting base;
3, support leg; 301, support cylinder; 302, first connecting piece; 303, second connecting piece; 304, first screw; 305, connecting base; 306, second screw; 307, protective cover.

### DESCRIPTION OF THE EMBODIMENTS

Technical solutions of the present disclosure are further described below with reference to accompanying drawings and specific implementations.

The accompanying drawings represent only schematic diagrams rather than actual objects, and should not be construed as limiting this application. For better description of embodiments of the present disclosure, some components in the drawings may be omitted, enlarged, or reduced, which do not represent actual product dimensions. It can be understood that, for those skilled in the art, some well-known structures and descriptions thereof may be omitted in the drawings.

In the drawings of the embodiments of the present disclosure, identical or similar reference numerals are corresponding to identical or similar components. In the description of the present disclosure, it should be understood that terms "upper", "lower", "left", "right", “inner”, “outer”, and other indicated directional or positional relationships are based on orientation or positional relationships shown in the drawings, and are only for ease of describing and simplifying the description of the present disclosure, and do not indicate or imply that indicated devices or elements need to have specific orientations or be constructed or operated in the specific orientations. Therefore, the terms describing the positional relationships in the drawings are for exemplary illustration only and should not be construed as limiting the present disclosure. For those of ordinary skill in the art, specific meanings of the above terms can be understood according to a specific context.

In the description of the present disclosure, unless otherwise expressly specified or limited, if a term "connection" or the like is used to indicate a connection relationship between components, the term should be interpreted broadly. For example, the connection may be a fixed connection, a detachable connection, or an integral connection; the connection may be a mechanical connection or an electrical connection; the connection may be a direct connection or an indirect connection through an intermediate medium; or the connection may be an internal communication between two components or an interaction between two components. For those skilled in the art, a specific meaning of the above terms in the present disclosure can be understood according to an actual situation.

### Embodiments

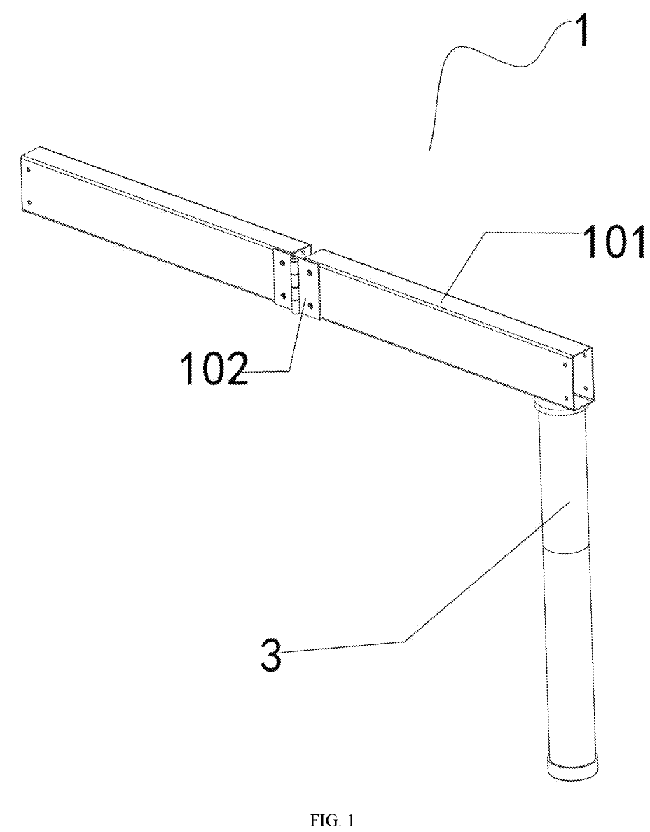

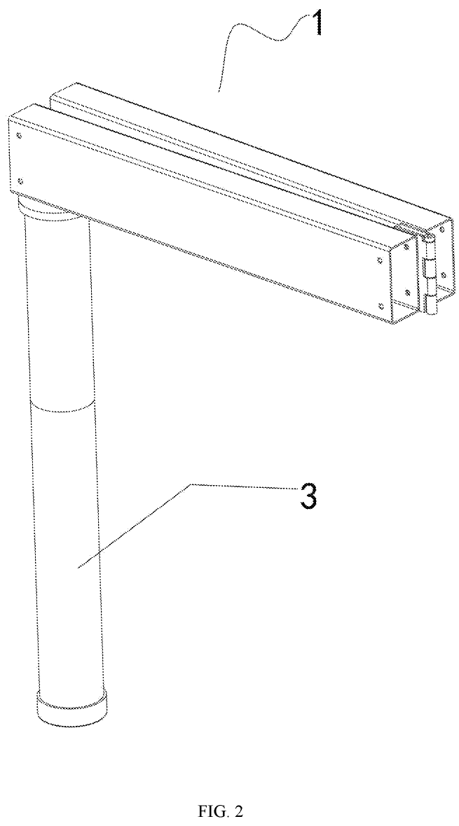

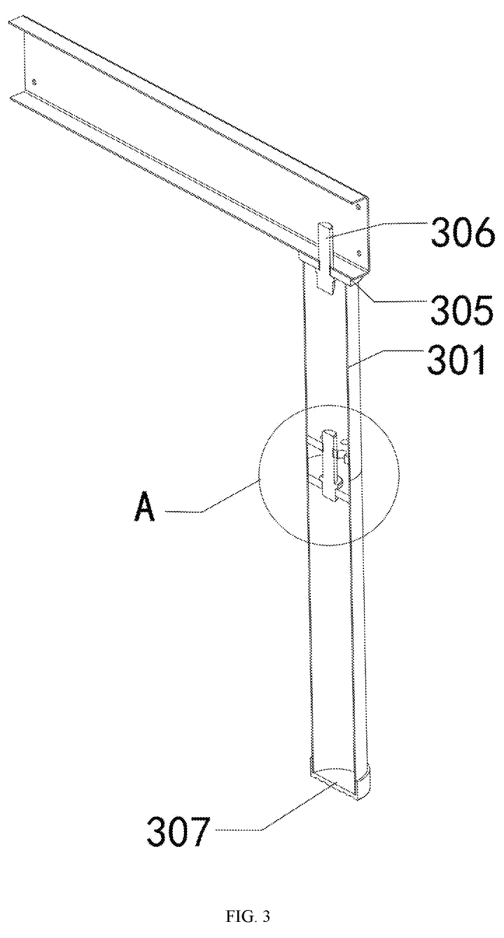

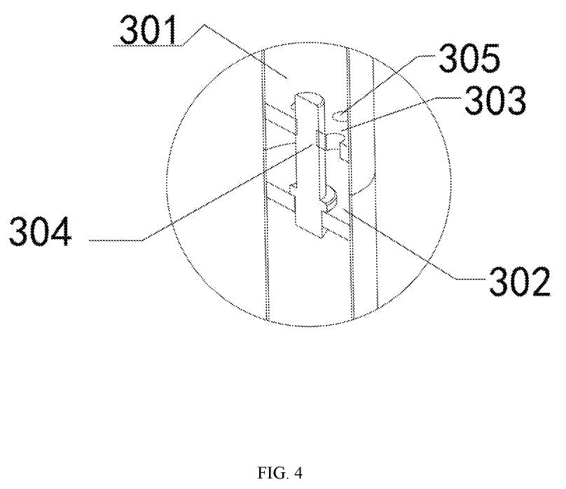

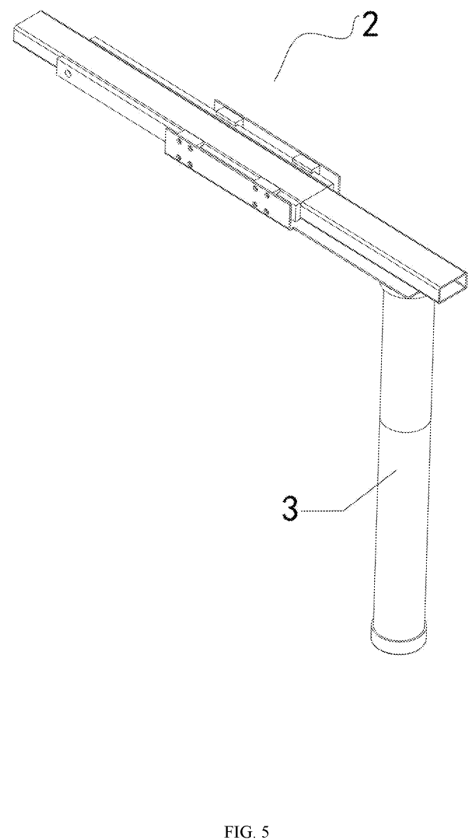

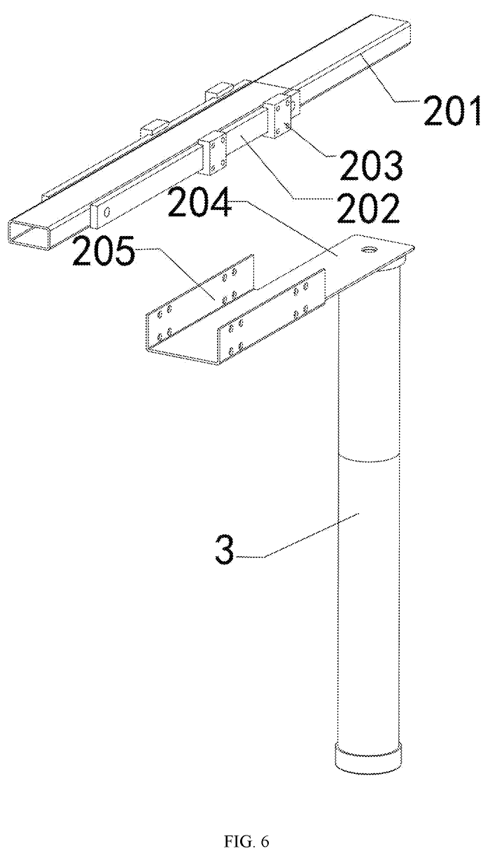

An extendable leg provided in the embodiments is shown in FIGS. 1-6, including: a support leg 3 mounted to a bottom of a bed frame through a first extendable member 1 or a second extendable member 2. The first extendable member 1 is a foldable structure; and the second extendable member 2 is a telescopic structure.

The support leg 3 is mounted to the bottom of the bed frame through the foldable first extendable member 1 or the telescopic second extendable member 2, so that the support leg 3 can be extended outward from the bed frame. This extension action expands a support range of the extendable leg for the bed frame, thereby improving overall support stability of the bed frame.

Specifically, in the embodiments, the first extendable member 1 includes at least two connecting square rods 101. Adjacent connecting square rods 101 are connected by a hinge 102, a bottom of an outermost connecting square rod 101 is connected to an upper end of the support leg 3, and an innermost connecting square rod 101 is fixedly mounted to the bottom of the bed frame.

At least two connecting square rods 101 in the first extendable member 1 are connected by the hinge 102, providing a foldable structural foundation for the first extendable member 1 and enabling a folding function. The innermost connecting square rod 101 is fixed to the bottom of the bed frame, providing a stable mounting carrier for the entire extendable leg. The outermost connecting square rod 101 is connected to the support leg 3, allowing the support leg 3 to be stably mounted on the extendable member and ensuring that the support leg 3 can adjust a position with the folding of the extendable member, thereby ensuring stability during mounting and use of the extendable leg.

Specifically, in the embodiments, adjacent connecting square rods 101 are connected by two symmetrically arranged hinges 102. After a hinge 102 on one side is removed, the adjacent connecting square rods 101 can be folded. Two symmetrically arranged hinges 102 disposed between the adjacent connecting square rods 101 can enhance a connection strength between the connecting square rods 101, preventing looseness of a connecting component at a connection part in an unfolded state. After the hinge 102 on one side is removed, the adjacent connecting square rods 101 can be smoothly folded, which ensures both connection stability and a folding function of the first extendable member 1, facilitating adjustment of a position of the support leg 3 through folding.

Specifically, in the embodiments, the second extendable member 2 includes a straight rod 201 fixedly mounted to the bottom of the bed frame, a slide rail 202 fixedly mounted on both sides of the straight rod 201, a U-shaped connecting base 205 slidably mounted on an outer side of the slide rail 202 through a slider 203, and a connecting plate 204 integrally formed at an outer end of the U-shaped connecting base 205. A bottom of one end of the connecting plate 204 away from the U-shaped connecting base 205 is connected to an upper end of the support leg 3. The straight rod 201 is fixed to the bottom of the bed frame, providing a stable mounting basis for the second extendable member 2. The slide rail 202 on both sides of the straight rod 201 cooperates with the slider 203 on the U-shaped connecting base 205, allowing the U-shaped connecting base 205 to drive the connecting plate 204 and the support leg 3 to slide along the slide rail 202, thereby implementing telescopic adjustment of the support leg 3 outward from the bed frame. The U-shaped connecting base 205 and the connecting plate 204 are integrally disposed, which can enhance a structural strength between the U-shaped connecting base 205 and the connecting plate 204, prevent breakage at a connection part during expansion and contraction, and ensure the stability of the support leg 3 during extension and retraction.

Specifically, in the embodiments, at least four sliders 203 are provided. The sliders 203 are slidably engaged with the slide rail 202, and the sliders 203 are fixedly connected to the U-shaped connecting base 205. The at least four sliders 203 are slidably engaged with the slide rail 202 and fixed to the U-shaped connecting base 205, increasing a contact point between the U-shaped connecting base 205 and the slide rail 202, distributing a pressure from the U-shaped connecting base 205 and the support leg 3, and preventing damage to an individual slider 203 due to an excessive force. In addition, this can prevent tilting or jamming of the U-shaped connecting base 205 during sliding, ensuring that the support leg 3 can be smoothly adjusted for extension and retraction.

Specifically, in the embodiments, the support leg 3 includes two support cylinders 301. A first connecting piece 302 is fixedly mounted inside a lower support cylinder 301, and a second connecting piece 303 is fixedly mounted inside an upper support cylinder 301. A connecting base 305 is fixedly mounted at an upper end of the upper support cylinder 301. The second connecting piece 303 is connected to the first connecting piece 302 by a first screw 304, and the connecting base 305 is connected to a bottom of the outermost connecting square rod 101 or a bottom of the connecting plate 204 by a second screw 306. The two support cylinders 301 of the support leg 3 are connected by the first connecting piece 302, the second connecting piece 303, and the first screw 304. Relative positions of the two support cylinders 301 are adjusted, and the first screw 304 is tightened, so that a length of the support leg 3 is adjusted to be adapted to different bed frame heights or floor level requirements. The connecting base 305 at the upper end of the upper support cylinder 301 is connected to the outermost connecting square rod 101 or the connecting plate 204 through the second screw 306, which allows the support leg 3 to be stably fixed to the extendable member, ensuring the reliability of a connection between the support leg 3 and the extendable member, and balancing length adjustment and mounting stability.

Specifically, in the embodiments, after the first screw 304 is tightened, a bottom end of the upper support cylinder 301 abuts against an upper end of the lower support cylinder 301. After the second screw 306 is tightened, the connecting base 305 abuts against a bottom of the connecting square rod 101 or a bottom of the connecting plate 204. After the first screw 304 is tightened, the bottom end of the upper support cylinder 301 abuts against the upper end of the lower support cylinder 301, eliminating a gap between the two support cylinders 301 and preventing shaking of the support leg 3 during use, thereby enhancing the support stability of the support leg 3. After the second screw 306 is tightened, the connecting base 305 abuts against the bottom of the connecting square rod 101 or the bottom of the connecting plate 204, eliminating a gap between the connecting base 305 and the connecting component, preventing looseness at a connection part between the support leg 3 and the extendable member, and further improving the overall support reliability of the extendable leg.

Specifically, in the embodiments, a protective cover 307 is sleeved on a bottom end of the lower support cylinder 301. The protective cover 307 is sleeved on the bottom end of the lower support cylinder 301, preventing a bottom end of the support cylinder 301 from directly contacting the floor, reducing wear on the support cylinder 301 caused by floor friction, extending the service life of the support leg 3, reducing noise generated when the support leg 3 moves or is subjected to force, and preventing the bottom end of the support cylinder 301 from scratching the floor.

In summary, the extendable leg in the embodiments implements multiple technical effects by using the combined design of the foldable first extendable member 1 or the telescopic second extendable member 2 and the support leg 3.
1. The support leg 3 can extend outward from the bed frame through folding of the first extendable member 1 or extraction and retraction of the second extendable member 2, thereby expanding a support range of the bed frame and significantly enhancing the overall support stability.
2. The support leg 3 has a structure in which the two support cylinders 301 are connected by the first connecting piece 302, the second connecting piece 303, and the first screw 304, allowing flexible adjustment of the length of the support leg, to meet different bed frame height or floor level requirements.
3. Fastening design of the first screw 304 and the second screw 306 eliminates gaps between the support cylinders 301 and between the support leg 3 and the extendable member, preventing shaking during use and further enhancing support reliability.
4. The protective cover 307 at the bottom end of the lower support cylinder 301 reduces wear on the support cylinder 301, extends service life, and lowers noise generated from contact with the floor, preventing floor scratches.
5. The hinge 102 of the first extendable member 1 and the cooperation between the slide rail 202 and slider 203 of the second extendable member 2 balance structural strength and ease of adjustment, ensuring that the support leg 3 is extended stably and smoothly.

Operating principle
1. Operating principle of the first extendable member 1 (foldable type): The first extendable member 1 includes at least two connecting square rods 101 connected through the hinge 102. The innermost connecting square rod 101 is fixed to the bottom of the bed frame, and the outermost connecting square rod 101 is connected to the support leg 3. In an unfolded state, two symmetrical hinges 102 fix the connecting square rods 101 as a whole, ensuring support stability. When extension is required, the hinge 102 on one side is removed, and adjacent connecting square rods 101 can rotate and fold around the other hinge 102, driving the support leg 3 to unfold outward from the bed frame, thereby expanding the support range.
2. Operating principle of the second extendable member 2 (telescopic type): The straight rod 201 of the second extendable member 2 is fixed to the bottom of the bed frame, with the slide rail 202 on both sides slidably engaged with the sliders 203 on the U-shaped connecting base 205. The U-shaped connecting base 205 is connected to the support leg 3 through the connecting plate 204. When the U-shaped connecting base 205 is pushed, the slider 203 slides along the slide rail 202, driving the support leg 3 to extend or retract outward from the bed frame, thereby implementing telescopic adjustment of a support position. At least four sliders 203 distribute a load, ensuring smooth and jam-free sliding.
3. Operating principle of the support leg 3: The two support cylinders 301 of the support leg 3 are connected by the first connecting piece 302, the second connecting piece 303, and the first screw 304. After the relative positions of the two cylinders are adjusted, the first screw 304 is tightened, so that the length of the support leg 3 can be fixed. The connecting base 305 is fixed to the connecting square rod 101 of the first extendable member 1 or the connecting plate 204 of the second extendable member 2 by the second screw 306, ensuring a stable connection between the support leg 3 and the extendable member, and transferring bed frame weight to the floor.

### Usage method

Usage method based on the first extendable member 1 (foldable type)
1. mounting: Fix the innermost connecting square rod 101 to the bottom of the bed frame, and connect the connecting base 305 of the support leg 3 to the bottom of the outermost connecting square rod 101 using the second screw 306.
2. Extension adjustment: Remove the hinge 102 on one side of one of adjacent connecting square rods 101, fold the connecting square rod 101 outward from the bed frame to a proper position, and retain the hinge 102 on the other side for fixation.
3. Support leg length adjustment: Loosen the first screw 304, adjust relative positions of the two support cylinders 301 to be adapted to floor flatness, and tighten the first screw 304 to enable the two cylinders to abut against each other and be fixed.
4. Storage: To retract, fold the connecting square rods 101 in opposite directions and remount the removed hinge 102.

Usage method based on the second extendable member 2 (telescopic type)
1. Mounting: Fix the straight rod 201 to the bottom of the bed frame, and connect the connecting base 305 of the support leg 3 to the bottom of the connecting plate 204 using the second screw 306.
2. Extension adjustment: Push the U-shaped connecting base 205, so that the slider 203 slides along the slide rail 202 outward from the bed frame, driving the support leg 3 to extend to a proper position.
3. support leg length adjustment: Same as the foldable type, loosen the first screw 304 to adjust a length of the support cylinder 301, and then tighten the support cylinder 301 for fixation.
4. Storage: Push the U-shaped connecting base 205 inward to retract the support leg 3 close to the bed frame.

### Common steps

Before use, check whether the protective cover 307 is mounted at a bottom end of the lower support cylinder 301 and ensure the protective cover 307 is securely in place.

After all adjustments are completed, check whether the first screw 304 and the second screw 306 are tightened to prevent loosening during use.

The above are only preferred embodiments of the present disclosure and are not intended to limit an implementation and a protection scope of the present disclosure. Those skilled in the art should recognize that all equivalent substitutions and obvious changes made based on the contents and drawings of the specification of the present disclosure are included within the protection scope of the present disclosure.

1. An extendable leg, comprising a support leg (3) mounted at a bottom of a bed frame through a first extendable member (1) or a second extendable member (2), wherein
the first extendable member (1) is a foldable structure; and the second extendable member (2) is a telescopic structure.

2. The extendable leg according to claim 1, wherein the first extendable member (1) comprises at least two connecting square rods (101), adjacent connecting square rods (101) are connected by a hinge (102), a bottom of an outermost connecting square rod (101) is connected to an upper end of the support leg (3), and an innermost connecting square rod (101) is fixedly mounted at the bottom of the bed frame.

3. The extendable leg according to claim 2, wherein the adjacent connecting square rods (101) are connected by two symmetrically arranged hinges (102), and after a hinge (102) on one side is removed, the adjacent connecting square rods (101) can be folded.

4. The extendable leg according to claim 1, wherein the second extendable member (2) comprises a straight rod (201) fixedly mounted at the bottom of the bed frame, a slide rail (202) fixedly mounted on both sides of the straight rod (201), a U-shaped connecting base (205) slidably mounted on an outer side of the slide rail (202) through a slider (203), and a connecting plate (204) integrally formed at an outer end of the U-shaped connecting base (205), wherein a bottom of one end of the connecting plate (204) away from the U-shaped connecting base (205) is connected to an upper end of the support leg (3).

5. The extendable leg according to claim 4, wherein at least four sliders (203) are provided, the sliders (203) are slidably engaged with the slide rail (202), and the sliders (203) are fixedly connected to the U-shaped connecting base (205).

6. The extendable leg according to claim 1, wherein the support leg (3) comprises two support cylinders (301), a first connecting piece (302) is fixedly mounted inside a lower support cylinder (301), a second connecting piece (303) is fixedly mounted inside an upper support cylinder (301), a connecting base (305) is fixedly mounted at an upper end of the upper support cylinder (301), the second connecting piece (303) is connected to the first connecting piece (302) by a first screw (304), and the connecting base (305) is connected to a bottom of an outermost connecting square rod (101) or a bottom of the connecting plate (204) by a second screw (306).

7. The extendable leg according to claim 6, wherein after the first screw (304) is tightened, a bottom end of the upper support cylinder (301) abuts against an upper end of the lower support cylinder (301); and after the second screw (306) is tightened, the connecting base (305) abuts against a bottom of the connecting square rod (101) or a bottom of the connecting plate (204).

8. The extendable leg according to claim 1, wherein a protective cover (307) is sleeved on a bottom end of the lower support cylinder (301).
